(19) United States
(12) Patent Application Publication
(10) Pub. No.: US 2004/0070271 A1
(43) Pub. Date: Apr. 15, 2004

(54) Apparatus and method of automatically braking in a stop state of a vehicle

(76) Inventor: Won-Bum Lee, Chungchungnam-do (KR)

Correspondence Address: NOTARO AND MICHALOS, 100 DUTCH HILL ROAD, SUITE 110, ORANGEBURG, NY, 10962-2100, US

(21) Appl. No.: 10/468,706

(22) PCT Filed: Feb. 22, 2002
(86) PCT No.: PCT/KR02/00296

(30) Foreign Application Priority Data
Feb. 23, 2001 (KR) 2001/9204

(51) Int. Cl. B60T 17/16

(52) U.S. Cl. 303/191; 303/89

(57) ABSTRACT

The present invention provides an apparatus and method of automatically braking a vehicle in a stop state by using a signal of a vehicle-speed sensor in a vehicle, and can be used as an alternative to a parking brake. A stop signal conversion means (20), an accelerator pedal sensing means (40), a stopping/running judgement means (50), a switch means (60) and a electromagnetically operated switching valve (70) are comprised. One of a high-level signal and a low-level signal from the vehicle-speed sensor (10) in the stop state of the vehicle by pressing the brake pedal is detected as it is, and the other one of a high-level signal and a low-level signal from the vehicle-speed sensor (10) is converted by a stop signal conversion means (20) and detecting the converted one. A brake line (L) is closed and the vehicle is braked by detecting the stop state using a single signal from the vehicle-speed sensor (10) although the pressing of the brake pedal may be released.

### TECHNICAL FIELD

The present invention relates to an apparatus and method of automatically braking in a stop state of a vehicle, and more particularly to an apparatus and method of automatically braking a vehicle in a stop state which can brake a vehicle automatically in a stop state by using a signal of a vehicle-speed sensor in a vehicle, can be applied to both of a hydraulic brake system and an air brake system, and can be used as an alternative to a parking brake.

### BACKGROUND ART

Generally, where the driver wants to run a vehicle with a manually shifted transmission again after stopping the vehicle on an upwardly inclined road by pressing a brake pedal, a vehicle proceeds in the reverse direction along the inclined road depending on the degree of inclination until before pressing an accelerator pedal after releasing the brake pedal. Therefore, the driver should press the accelerator pedal quickly right after releasing the brake pedal. Otherwise, there is a danger that his vehicle collides with the next forwarding vehicle.

Meanwhile, after stopping the vehicle, the driver brakes the vehicle using a separate parking brake so that the vehicle may not move. However, there is also a danger that the braking force of the parking brake becomes released depending on the degree of inclination while the vehicle is stopped or parked on an upwardly inclined road using the parking brake.

### DISCLOSURE OF INVENTION

Accordingly, the present invention is made in order to solve the above problems, and one object of the present invention is to provide an apparatus and method of automatically braking a vehicle in a stop state which can brake a vehicle automatically in a stop state by using a signal of a vehicle-speed sensor in a vehicle, can be applied to both of a hydraulic brake system and an air brake system, and can be used as an alternative to a parking brake.

To accomplish the object of this invention, an apparatus and method of automatically braking a vehicle in a stop state is provided in accordance with one embodiment of the invention, which has a vehicle-speed sensor generating a rectangular shaped signal for representing a running speed of the vehicle, and brakes the vehicle by operating a wheel brake device by means of a brake pedal, the apparatus comprising: a stop signal conversion means for outputting a running signal of a rectangular shape using the rectangular shaped signal during the running state of the vehicle, and for outputting a stop signal of a low-level signal or a high-level signal after converting the rectangular shaped signal of a high-level signal or a low-level signal generated by the vehicle-speed sensor during the stop state of the vehicle until the vehicle is moved or running; an accelerator pedal sensing means installed so as to detect the pressing of an accelerator pedal, outputting an acceleration signal of a high-level signal or a low-level signal during an accelerator pedal pressing state, and outputting a stoppage signal during an acceleration pedal releasing state; a stopping/running judgement means having a first input terminal and a second input terminal each of which is connected to each output terminal of the stop signal conversion means and the accelerator pedal sensing means, respectively, outputting an open signal in the running state in which the running signal or the acceleration signal is inputted from one output terminal of the stop signal conversion means and the accelerator pedal sensing means to the first input terminal or the second input terminal, and outputting a close signal in the stop state in which the stop signal and the stoppage signal are inputted from both output terminals of the stop signal conversion means and the accelerator pedal sensing means to the first input terminal and the second input terminal; a switch means which is operated or is not operated by the open signal or the close signal outputted from the stopping/running judgement means; and an electromagnetically operated switching valve which is installed in a hydraulic or pneumatic brake line L connected to the wheel brake device 80, and is controlled by the switch means in such a manner that the hydraulic or pneumatic brake line L becomes open when the switch means is operated or is not operated by the open signal from the stopping/running judgement means and the hydraulic or pneumatic brake line L becomes closed when the switch means is operated or is not operated by the close signal from the stopping/running judgement means, thereby maintaining the braked stop state of the vehicle and preventing the movement of the vehicle before the running of the vehicle or just before the pressing of the accelerator pedal after the stoppage of the vehicle although the brake pedal may be released.

In this case, said apparatus may further comprise a brake pedal sensing means which detects the pressing of the brake pedal and is connected between the output terminal of the stop signal conversion means and the first input terminal of the stopping/running judgement means so as to output a stop signal after blocking a signal from the stop signal conversion means during a brake pedal pressing state, and output the running signal or the stop signal from the stop signal conversion means to the first input terminal of the stopping/running judgement means during a brake pedal releasing state. Also, the electromagnetically operated switching valve may be of a normally closed type and function as a parking brake by supplying the electric power source (+12V) of the vehicle to the automatic brake apparatus when a key switch of the vehicle is operated and maintaining the hydraulic or pneumatic brake line L in the close state through the electromagnetically operated switching valve in the parking state in which the electric power source (+12V) of the vehicle is cut off. Further, said electromagnetically operated switching valve may further comprises an emergency bypath valve of a manual type in parrallel to the electromagnetically operated switching valve so as to release the braking force in the parking state.

Furthermore, the present invention is to provide a method of automatically braking in a stop state a vehicle, which has a vehicle-speed sensor generating a rectangular shaped signal for representing a running speed of the vehicle, and brakes the vehicle by operating a wheel brake device by means of a brake pedal, the method comprising the steps of: detecting one of a high-level signal and a low-level signal as it is if the one of a high-level signal and a low-level signal is generated by the vehicle-speed sensor when the vehicle stops by pressing the brake pedal; detecting one of a high-level signal and a low-level signal converted from the other one of a high-level signal and a low-level signal by a stop signal conversion means if the other one of a high-level signal and a low-level signal is generated by the vehicle-speed sensor when the vehicle stops by pressing the brake pedal, and detecting the converted one; closing a hydraulic or pneumatic brake line L and braking the vehicle by detecting the stop state of the vehicle using a single signal from the vehicle-speed sensor although the pressing of the brake pedal may be released.

### BRIEF DESCRIPTION OF DRAWINGS

FIG. 1 shows a block diagram illustrating the construction of an apparatus for automatically braking a vehicle in a stop state according to the invention.

FIGS. 2 to 5 illustrate in detail the construction of an apparatus for automatically braking the vehicle in a stop state according to several embodiments of the invention.

### BEST MODE FOR CARRYING OUT THE INVENTION

Now, a preferred embodiment of the present invention will be described in detail with reference to the accompanying drawings.

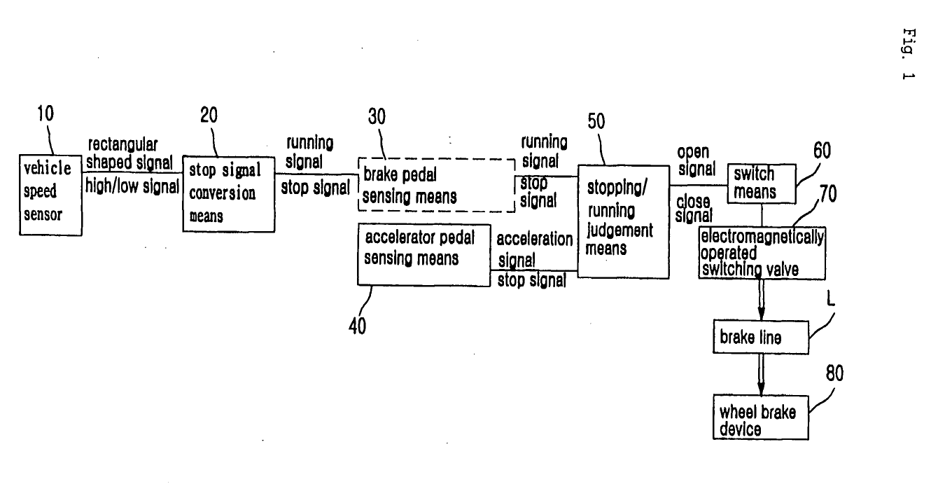

One construction of an apparatus for automatically braking a vehicle in a stop state according to the present invention is illustrated as a block diagram in FIG. 1.

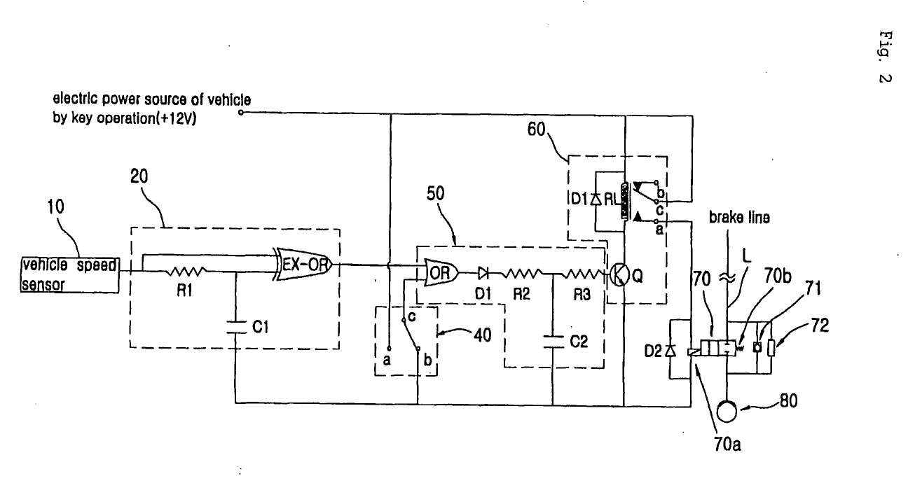

In FIG. 1, the apparatus for automatically braking a vehicle in a stop state comprises a vehicle-speed sensor 10 generating a rectangular shaped signal for representing a running speed of the vehicle, and a wheel brake device 80 (shown in FIG. 2) for braking the vehicle by footing or pressing a brake pedal, and further comprises a stop signal conversion means 20, an accelerator pedal sensing means 40, a stopping/running judgement means 50, a switch means 60 and an electromagnetically operated switching valve 70 basically. Also, it may further comprise brake pedal sensing means 30. Further, it is preferable that the present invention comprises a check valve 71 and/or an emergency by-pass valve 72 as shown in FIGS. 2 to 5.

As shown in FIG. 1, the stop signal conversion means 20 is constructed to output a running signal of a rectangular shape using the rectangular shaped signal of the vehicle-speed sensor 10 during the running state of the vehicle, and to output a stop signal of a low-level signal (or a high-level signal if a close signal of the aftermentioned stopping/running judgement means 50 is a high-level signal: the “if” clause will be omitted hereinafter) after converting, into a signal of a low-level signal (or a high-level signal), the rectangular shaped signal of a high-level signal (or a low-level signal) generated by the vehicle-speed sensor 10 during the stop state of the vehicle until the vehicle is moved or running.

The brake pedal sensing means 30 may be further installed so as to detect the pressing of the brake pedal. In this case, the brake pedal sensing means 30 is connected to the stop signal conversion means 20 so as to output a stop signal after blocking a signal from the stop signal conversion means 20 during a brake pedal pressing state, and to output the running signal or the stop signal from the stop signal conversion means 20 during a brake pedal releasing state.

The accelerator pedal sensing means 40 is installed so as to detect the pressing of an accelerator pedal, and is constructed so as to output an acceleration signal of a high-level signal (or a low-level signal) during an accelerator pedal pressing state, and to output a stoppage signal of a low-level signal (or a high-level signal) during an acceleration pedal releasing state.

The stopping/running judgement means 50 has a first input terminal and a second input terminal. Each of the first input terminal and the second input terminal is connected to each output terminal of the stop signal conversion means 20 (an output terminal of the brake pedal sensing means 30 if installed) and the accelerator pedal sensing means 40, respectively. The stopping/running judgement means 50 is constructed to output an open signal after judging the vehicle to be in the running state when the running signal or the acceleration signal is inputted from one output terminal of the stop signal conversion means 20 and the accelerator pedal sensing means 40 to the first input terminal or the second input terminal, and to output a close signal after judging the vehicle to be in the stop state when each of the stop signal and the stoppage signal are inputted from each output terminal of the stop signal conversion means 20 and the accelerator pedal sensing means 40 to the first input terminal and the second input terminal.

The switch means 60 may be constructed to be driven by the open signal or the close signal outputted from the stopping/running judgement means 50.

The electromagnetically operated switching valve 70 for a hydraulic or a pneumatic use is employed depending on a hydraulic or pneumatic brake line L to become open or closed. The electromagnetically operated switching valve 70 is installed in the hydraulic or pneumatic brake line L to be connected to the wheel brake device 80 and is constructed to be controlled by the switch means 60 in such a manner that the hydraulic or pneumatic brake line L becomes open when the switch means 60 is operated or is not operated by the open signal from the stopping/running judgement means 50, and that the hydraulic or pneumatic brake line L becomes closed when the switch means 60 is operated or is not operated by the close signal from the stopping/running judgement means 50. That is, the electromagnetically operated switching valve 70 may be constructed to be controlled by one solenoid 70a and one spring 70b, and be one to be normally closed when the switch means 60 is driven (turn on) by the open signal to energize the solenoid 70a. Also, the electromagnetically operated switching valve 70 of a normally open type may be employed to be normally open when the switch means 60 is not driven (turn off) by the open signal to deenergize the solenoid 70a, thereby capable of opening the hydraulic or pneumatic brake line L. Besides, various modifications are possible depending on the construction of the electromagnetically operated switching valve 70 and the switch means 60.

By such a construction, when the vehicle is stopped by releasing the accelerator pedal and pressing the brake pedal during the running state of the vehicle, the stop signals from the stop signal conversion means 20 and the accelerator pedal sensing means 40 are inputted to the stopping/running judgement means 50, thereby being capable of judging the vehicle to be in the stop state in the stopping/running judgement means 50. In case the brake pedal sensing means 30 is comprised, the brake pedal sensing means 30 outputs the stop signal after blocking a signal from the stop signal conversion means 20 during a brake pedal pressing state, and also the stop signal from the accelerator pedal sensing means 40 is inputted to the stopping/running judgement means 50, thereby being capable of judging the vehicle to be in the stop state. Thus, the stop signal conversion means 20 outputs the close signal and the electromagnetically operated switching valve 70 is closed through the switch means 60, thereby closing the hydraulic or pneumatic brake line L and maintaining the braking state. Also, it is preferable that the present invention further comprises a check valve 71 in parallel to the electromagnetically operated switching valve 70 as shown in FIGS. 2 to 5, or the check valve 71 is installed in the electromagnetically operated switching valve 70 so that an increased pressure of the hydraulic or pneumatic brake line L can be transmitted to the wheel brake device 80, thereby further being capable of pressing the brake pedal and increasing the braking force after the electromagnetically operated switching valve 70 is closed. Particularly, by installing the check valve 71, any effect is not exerted on the original function to press the brake pedal and brake the vehicle. Also, although the apparatus for automatically braking a vehicle in a stop state according to the present invention is broken due to the damage of the solenoid, the relay RL, etc., safety can be ensured since the original function of the brake system can be maintained when the normally closed electromagnetically operated switching valve 70 as mentioned later is employed.

Thus, when the close signal is a low-level signal and a signal of the vehicle-speed sensor 10 detecting a stop state of the vehicle is a high-level signal, the high-level signal is converted to a low-level signal and the low-level signal is outputted as the stop signal. And when the signal of the vehicle-speed sensor 10 detecting a stop state of the vehicle is a low-level signal, the low-level signal itself is outputted as the stop signal. Therefore, when a low-level signal as the stoppage signal is outputted during an acceleration pedal releasing state, the vehicle is judged to be in the stop state and the close signal o: the low-level signal is outputted in the stopping/running judgement means 50, thereby continuously maintaining the electromagnetically operated switching valve 70 and the hydraulic or pneumatic brake line L in the close state although the pressing of the brake pedal is released after the vehicle stops.

Also, when the close signal is a high-level signal and a signal of the vehicle-speed sensor 10 detecting a stop state of the vehicle is a low-level signal, the low-level signal is converted to a high-level signal and the high-level signal is outputted as the stop signal. And when the signal of the vehicle-speed sensor 10 detecting a stop state of the vehicle is a high-level signal, the high-level signal itself is outputted as the stop signal. Therefore, when a high-level signal as the stoppage signal is outputted from the accelerator pedal sensing means 40 during an acceleration pedal releasing state, the vehicle is judged to be in the stop state and the close signal of the high-level signal is outputted in the stopping/running judgement means 50, thereby continuously maintaining the electromagnetically operated switching valve 70 and the hydraulic or pneumatic brake line L in the close state although the pressing of the brake pedal is released after the vehicle stops. Even in this case, a low-level signal can become the close signal by converting the high-level signal into the low-level signal.

Thus, the braking state of the vehicle can be continuously maintained before the running of the vehicle or just before the pressing of the accelerator pedal after the stoppage of the vehicle although the brake pedal may be released after the vehicle stops. Particularly, the movement of the vehicle can be prevented in the inclined road.

When the accelerator pedal sensing means 40 is pressed again, before the vehicle stops in the above, or for restarting after the vehicle stops, the brake pedal is released and the brake pedal sensing means 30 outputs the rectangular shaped running signal in case of comprising the brake pedal sensing means 30. However, since the acceleration signal is inputted to the stopping/running judgement means 50 from the accelerator pedal sensing means 40 regardless of the the signal from the brake pedal sensing means 30, the vehicle is judged to be in the running state and the stopping/running judgement means 50 outputs the open signal, thus the electromagnetically operated switching valve 70 becomes open through the switch means 60, the hydraulic or pneumatic brake line L becomes open, and the vehicle is maintained to be in the accelerated running state.

Furthermore, when the brake pedal is released before the vehicle stops and the accelerator pedal is not pressed yet, the stoppage signal is outputted from the accelerator pedal sensing means 40. However, since the running signal is outputted from the stop signal conversion means 20, the vehicle is judged to be in the running state and the stopping/running judgement means 50 outputs the open signal, thus the electromagnetically operated switching valve 70 and the hydraulic or pneumatic brake line L become open, and the vehicle is maintained to be in the running state.

Meanwhile, in the construction to omit the brake pedal sensing means 30, a first input terminal and a second input terminal of the stopping/running judgement means 50 is connected to each output terminal of the stop signal conversion means 20 and the accelerator pedal sensing means 40, respectively, thus the stopping/running judgement means 50 judges the vehicle to be in the running state when the running signal or the acceleration signal is inputted from one output terminal of the stop signal conversion means 20 and the accelerator pedal sensing means 40 to the stopping/running judgement means 50, thereby outputting an open signal. And, the stopping/running judgement means 50 judges the vehicle to be in the stop state, when the stop signal and the stoppage signal are inputted from both output terminals of the stop signal conversion means 20 and the accelerator pedal sensing means 40 to the stopping/running judgement means 50, thereby outputting a close signal

To prevent a rotation of the vehicle by maintaining the symmetrical brake forces, it is preferred that the electromagnetically operated switching valve 70 is installed in the hydraulic or pneumatic brake line L symmetrically in the right and left. Furthermore, it is preferably that the electromagnetically operated switching valve 70 is not installed in the particular vehicle wheel to which the vehicle-speed sensor 10 is installed and in the vehicle wheel symmetrical to the particular vehicle wheel. In this case, while the vehicle is sliding without stopping although the vehicle wheels are stopped by pressing the brake pedal (tire-lock phenomenon), the rectangular shaped running signal is outputted from the vehicle-speed sensor 10, the vehicle wheel, in which the vehicle-speed sensor 10 is installed and the electromagnetically operated switching valve 70 is not installed, is rotated by releasing the pressing of the brake pedal hastily and the rectangular shaped running signal becomes outputted from the vehicle-speed sensor 10. Therefore, in case of comprising the stop signal conversion means 20 and the brake pedal sensing means 30, the open signal becomes outputted through the brake pedal sensing means 30 and the stopping/running judgement means 50, thereby opening the electromagnetically operated switching valve 70 through the switch means 60 at once, and being capable of forwarding the vehicle in the running direction by its inertia even before pressing the accelerator pedal.

A variety type of the electromagnetically operated switching valves 70 can be employed depending on a design. For, example, the electromagnetically operated switching valve 70 of the normally closed type is employed in FIGS. 2 to 5, and may comprise one solenoid 70a and one spring 70b designed to become open when the solenoid 70a is energized and to become closed when the solenoid 70a is de-energized. In this case, by the embodiment constructed so as to supply the electric power source (+12V) of the vehicle to the automatic brake apparatus when a key switch of the vehicle is operated, the electromagnetically operated switching valve 70 functions as a parking brake since the hydraulic or pneumatic brake line L is maintained to be in the close state through the electromagnetically operated switching valve 70 closed even in the parking state in which the electric power source (+12V) of the vehicle is cut off, beside the stop state of the vehicle. Also, in this case, it is preferred that a manual emergency by-pass valve 72 is further installed in parallel to the electromagnetically operated switching valve 70 so as to enable the manual releasing of the braking force in the parking state.

In FIGS. 2 to 4, the construction is illustrated as one concrete embodiment of FIG. 1, wherein the close signal and the stop signal are of a low-level signal and the relay RL is driven during the running state. The numerical reference “D2” is a diode for protecting the relay RL.

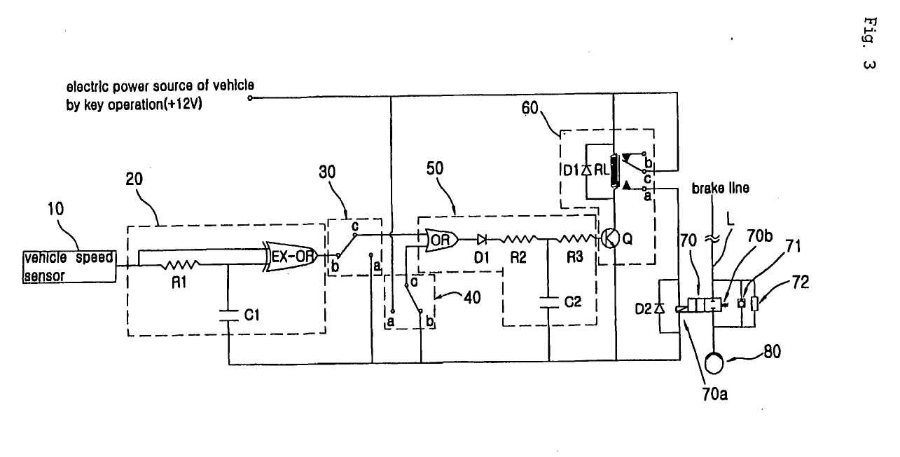

One embodiment of the stop signal conversion means 20 as shown in FIGS. 2 and 3 comprises an exclusive OR gate EX-OR, a resistor R1 and a condenser C1, in which a rectangular shaped signal of the vehicle-speed sensor 10 is inputted to a first input terminal of the exclusive OR gate EX-OR as it is, and the signal of the vehicle-speed sensor 10 is inputted to a second input terminal of the exclusive OR gate EX-OR after a first delayed time T1. Thus, the exclusive OR gate EX-OR outputs a high-level signal or a low-level signal continuously in the stop state of the vehicle. That is, when the signal of the vehicle-speed sensor 10 detecting the stop state of the vehicle is a low-level signal, the low-level signal becomes outputted from an output terminal of the exclusive OR gate EX-OR since a low-level signal is inputted to both first and second input terminals of the exclusive OR gate EX-OR. When the signal detected in the vehicle-speed sensor 10 in the stop state of the vehicle is a high-level signal, although a low-level signal is inputted to the second input terminal of the exclusive OR gate EX-OR for the first delayed time T1 to charge the condenser C1 at the outset, then the low-level signal is converted into the high-level signal and the high-level signal is inputted to the second input terminal as in the first input terminal, the low-level signal being outputted from the output terminal of the exclusive OR gate EX-OR, and consequently the high-level signal being converted to a low-level signal to be outputted from the exclusive OR gate EX-OR after the first time delay.

In a high speed in which a pulse width T of a high-level signal part in the rectangular shaped signal of the vehicle-speed sensor 10 is smaller than the first time delay T1 (T<T1), a low-level signal is inputted to the second input terminal of the exclusive OR gate EX-OR since the condenser C1 is charged by high-level signal part for the time of the pulse width T and then is discharged to the vehicle-speed sensor 10 while a low-level signal part of the rectangular shaped signal is inputted from the vehicle-speed sensor 10, thes the rectangular shaped signal to be inputted in the first input terminal of the exclusive OR gate EX-OR becomes outputted from the exclusive OR gate EX-OR. In a low speed in which a pulse width T of a high-level signal part in the rectangular shaped signal of the vehicle-speed sensor 10 is greater than the first time delay T1 (T>T1), although a high-level signal is inputted to the first input terminal and a low-level signal to the second input terminal for the first delayed time T1 to charge the condenser C1 at the outset, thereby a high-level signal being outputted in the exclusive OR gate EX-OR, a high-level signal is inputted to both input terminal of the exclusive OR gate EX-OR after the first delayed time T1, thereby the low-level signal being outputted from the exclusive OR gate EX-OR. Also, in the similar manner at the end point of the pulse width T of the high-level signal part in the rectangular shaped signal of the vehicle-speed sensor 10, a high-level signal becomes outputted from the exclusive OR gate EX-OR, in which the frequency of the rectangular shaped signal from the vehicle-speed sensor 10 increases by positive number times such as twice or three times. In the actual application in which the length of the vehicle wheel is around 180 cm and four pulses are generated from the vehicle-speed sensor 10 by one rotation of the vehicle wheel, the vehicle runs at the speed of 45 cm per one pulse period (22.5 cm per a pulse width). In the first delayed time T1 of 0.329 second, the rectangular shaped pulses of the vehicle-speed sensor 10 is multiplied when the vehicle moves at the speed below 22.5 cm per pulse for 0.329 second.

Equivalent logic circuits can be employed for the above-mentioned exclusive OR gate EX-OR and equivalent circuits for the above-mentioned condenser C1 and the resistor R1.

In FIG. 3, the brake pedal sensing means 30 comprises a switch means having a first to a third contact points a, b and c, and installed in a relationship with the brake pedal in such a manner that the third contact point c as the output terminal thereof can be switched between the first contact point a connected to ground of the vehicle for outputting the stoppage signal of a low-level signal when the brake pedal is pressed, and the second contact point b connected to the stop signal conversion means 20 when the brake pedal is depressed. And, in the similar manner to the brake pedal sensing means 30, the accelerator pedal sensing means 40 comprises a switch means having a first to a third contact points a, b and c, and installed in a relationship with the accelerator pedal in such a manner that the third contact point c as the output terminal thereof can be switched between the first contact point a connected to an electric power source (+12V) of the vehicle by operating a key switch of the vehicle for outputting the acceleration signal of a high-level signal when the accelerator pedal is pressed, and the second contact point b connected to ground of the vehicle for outputting the stoppage signal of a low-level signal when the accelerator pedal is depressed. In FIG. 2, the construction in which the brake pedal sensing means 30 is omitted is illustrated.

In FIG. 2, the stopping/running judgement means 50 comprises an OR gate OR whose first input terminal and second input terminal are connected to the stop signal conversion means 20 and the third contact point c of the accelerator pedal sensing means 40, and which outputs the rectangular shaped running signal or the acceleration signal of a high-level signal, or the stoppage signal of a low-level signal as the open or close signal. And the stopping/running judgement means 50 further comprises a resistor R2, a condenser C2 and a resistor R3 so as to output the open signal in which a potential of the rectangular shaped running signal becomes smooth and is maintained above a potential maintaining a collector current of the transistor means Q above a current for maintaining a energized state of the relay RL, thereby preventing from releasing the driven state of transistor means Q and the relay RL of the switch means 60 although the rectangular shaped running signal is inputted to, and outputted as the open signal from, the OR gate OR, and preventing from opening and closing the electromagnetically operated switching valve 70 periodically.

Thus, by comprising the resistor R2, the condenser C2 and the resistor R3 and making a resistance of the resistor R3 greater than that of the resistor R2, the discharging time of the condenser C2 becomes longer than its charging time, thereby even the rectangular shaped running signal being made smooth by means of the condenser C2 and the resistor R3 and the relay RL being maintained in the energized state without the relay RL cut off. Also, even in case the vehicle is running above a very low speed corresponding to a current for maintaining the relay RL in the energized state without completely depressing the brake pedal, the relay RL is maintained in the energized state, thereby the electromagnetically operated switching valve 70 being maintained in the open state and the braking force advantageously being capable of being changed by the pressing force of the brake pedal.

In FIG. 3, similarly to in FIG. 2, the stopping/running judgement means 50 comprises an OR gate OR whose first input terminal and second input terminal are connected to the brake pedal sensing means 30 and the third contact point c of the accelerator pedal sensing means 40, and which outputs the rectangular shaped running signal or the acceleration signal of a high-level signal, or the-stoppage signal of a low-level signal as the open or close signal. And the stopping/running judgement means 50 further comprises a resistor R2, a condenser C2 and a resistor R3 so as to output the open signal in which a potential of the rectangular shaped running signal becomes smooth and is maintained above a potential maintaining a collector current of the transistor means Q above a current for maintaining a energized state of the relay RL, thereby preventing from releasing the driven state of transistor means Q and the relay RL of the switch means 60 although the rectangular shaped running signal is inputted to, and outputted as the open signal from, the OR gate OR, and preventing from opening and closing the electromagnetically operated switching valve 70 periodically.

Also in this case, the rectangular shaped running signal to be inputted becomes smooth by the condenser C2 and the resistors R2 and R3, and the relay RL can be maintained continuously in the energized state, as in FIG. 2. However, if a delayed time by the condenser C2 and the resistor R3 is 0.616 second, the electromagnetically operated switching valve 70 will be operated after the brake pedal is pressed for the total delayed time of 0.945 second adding the first delayed time T1 of 0.329 second. A diode D1 is for preventing the reverse discharge of the condenser C2.

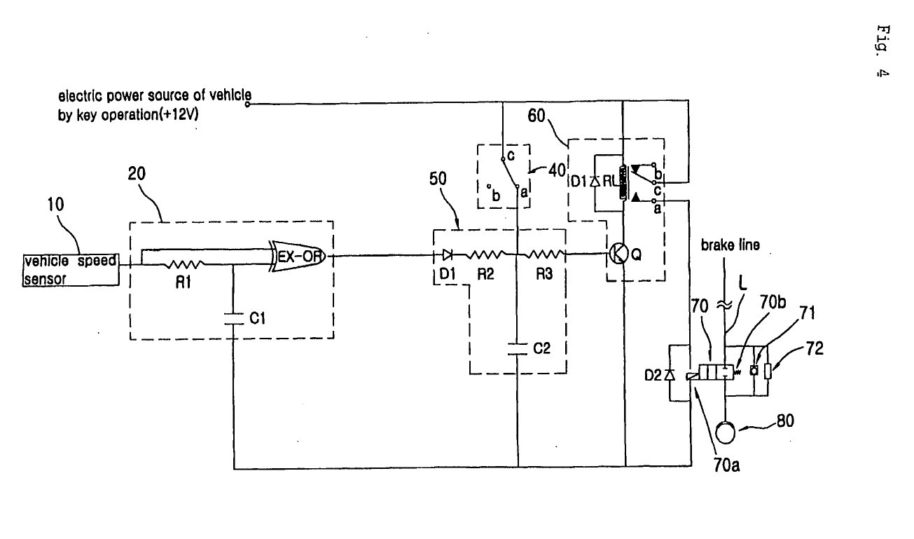

In FIG. 4, the stopping/running judgement means 50 is constucted by connecting the output terminal of the stop signal conversion means 20 and a contact point a of the accelerator pedal sensing means 40 so as to output, as the open signal or the close signal, the rectangular shaped running signal or the acceleration signal of a high-level signal, or the stoppage signal of a low-level signal, instead of the OR gate OR in FIG. 2. Here, the accelerator pedal sensing means 40 comprises a switch means having a contact point c connected to an electric power source (+12V) of the vehicle by operating a key switch of the vehicle and a contact point a connected to the stopping/running judgement means 50 (preferably between the resistors R2 and R3), and installed in a relationship with the accelerator pedal in such a manner that the contact points a and c will become connected or disconnected to each other so as to output the acceleration signal of a high-level signal in the accelerator pedal pressing state, and the stoppage signal of a low-level signal in an accelerator pedal depressing state, to the stopping/running judgement means 50.

In FIGS. 2 to 4, the switch means 60 comprises a transistor means Q of an NPN type which base is connected to an output terminal of the OR gate OR (the exclusive OR gate EX-OR in FIG. 4) through the resistor R2 and R3 and which is driven when the open signal is inputted and is not driven when the close signal is inputted, and a relay RL which is connected between the electric power source (+12V) during the operation of the key switch and a collector of the transistor means Q, and which is energized in the driven state of the transistor means Q and de-energized in the non-driven state. For a large capacity, the switch means 60 may further comprise a relay, and if the use current is a few hundred mA, the transistor means Q is preferably replaced by the Darlington circuit type. Also, other resistors for protecting IC may be comprised by the prior art which is not shown.

Furthermore, in FIGS. 2 to 4, the electromagnetically operated switching valve 70 of the normally closed type which is operated by the solenoid 70a and the spring 70b is employed and functions as a parking brake in the parking state of the vehicle by being connected to the contact point a of the relay RL. However, it is disadvantagous that the electric current should be supplied to the electromagnetically operated switching valve 70 during the running of the vehicle. In case of a electromagnetically operated switching valve 70 of a normally open type, a contact point b of the relay RL and the electric current is advantageously supplied only in the stop state of the vehicle, but it is disadvantage that the electromagnetically operated switching valve 70 can not function as a parking barke.

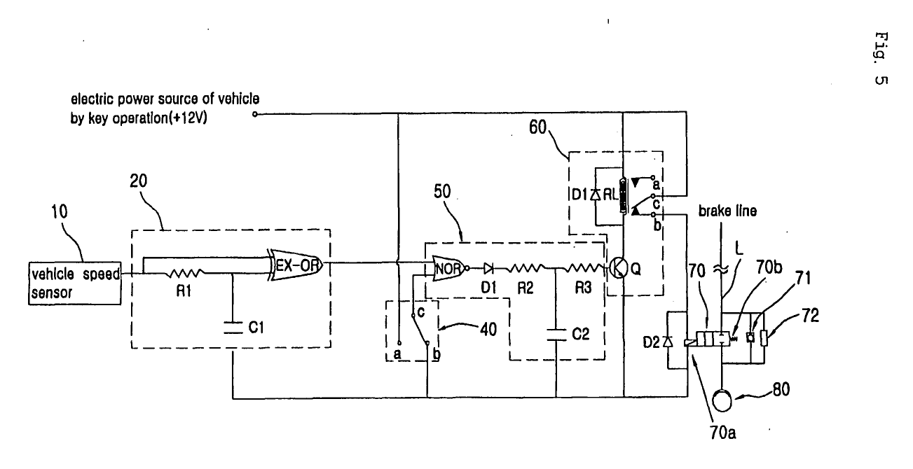

In FIG. 5, the construction is ilustrated in which the stop signal is a low-level signal, the close signal is a high-level signal, and the relay RL is operated in the stop state of the vehicle.

In FIG. 5, the constructions of the stop signal conversion means 20, the accelerator pedal sensing means 40 and the switch means 60 are similar to those in FIG. 2. However, as the stopping/running judgement means 50, a NOR gate NOR is employed, of which a first input terminal and a second input terminal are connected to the stop signal conversion means 20 and the contact point c of the accelerator pedal sensing means 40, thereby outputting as the open signal or the close signal after reversely converting the rectangular shaped running signal, the acceleration signal of a high-level signal, or the stop signal of a low-level signal.

In this case, the transistor means Q is connected to the output terminal of the NOR gate NOR and becomes a non-driven state when the open signal is inputted, thereby the relay RL being deenergized. And, the transistor means Q is driven when the close signal of a high-level signal, thereby the relay RL being energized. Thus, the electromagnetically operated switching valve 70 becomes open and closed. For the electromagnetically operated switching valve 70 of a normally closed type, a contact point b of the relay RL will be used, and for a normally open type, a contact point a will be used.

Also, when the close signal is a high-level signal and the stop signal is a high-level signal, the stopping/running judgement means 50 comprises an AND gate instead of the OR gate OR, which is not shown. When a high-level signal is inputted to both input terminals of the AND gate, the high-level signal is outputted as the close signal, thereby determining the stop state of the vehicle. Further, the EX-NOR gate can be replaced by the exclusive OR gate EX-OR for converting the stop signal into a high-level signal. Many variations and modifications of the embodiments described herein can be made in carrying out the above apparatus and method set forth within the spirit and scope of the present invention.

As known from the above the above-described construction and acting of the apparatus for automatically braking a vehicle in a stop state, the method of automatically braking a vehicle in a stop state comprises the steps of detecting one of a high-level signal and a low-level signal as it is if the one of a high-level signal and a low-level signal is generated by the vehicle-speed sensor 10 when the vehicle stops by pressing the brake pedal; detecting one of a high-level signal and a low-level signal converted from the other one of a high-level signal and a low-level signal by a stop signal conversion means 20 if the other one of a high-level signal and a low-level signal is generated by the vehicle-speed sensor 10 when the vehicle stops by pressing the brake pedal, and detecting the converted one; and closing a hydraulic or pneumatic brake line L and braking the vehicle by detecting the stop state of the vehicle using a single signal from the vehicle-speed sensor 10 although the pressing of the brake pedal may be released. That is, although the vehicle-speed sensor 10 may generate a high-level signal or a low-level signal when the vehicle stops, only one of a high-level signal and a low-level signal can be outputted as the stop signal according to the present invention. Therefore, by discriminating from the rectangular shaped running signal, the present invention can be aplied to the prior art apparatus for automatically braking a vehicle in a stop state or an ABS brake system, etc., besides the above-mentioned apparatus and method. In case of the ABS system, it can be more simplified by replacing the vehicle-speed sensor 10 by a vehicle wheel sensor or by closing a hydraulic or pneumatic brake line with a simple operation of an exit valve in the stop state of the vehicle.

According to the configuration and acting of the apparatus and method of automatically braking a vehicle in a stop state in accordance with the embodiments of the present invention described above, the vehicle can be braked automatically in the stop state with a brief configuration by using the signal of the vehicle-speed sensor. Also, the apparatus can be applied to both of a hydraulic brake system and an air brake system, and can be used as an alternative to a parking brake.

Although the present invention has been described in detail with respect to several preferred embodiments thereof, it will be apparent for those skilled in the art that various modifications are possible with respect to the shown embodiments within the scope of the present invention.

1. An apparatus for automatically braking a vehicle in a stop state, which has a vehicle-speed sensor 10 generating a rectangular shaped signal for representing a running speed of the vehicle, and brakes the vehicle by operating a wheel brake device 80 by means of a brake pedal, the apparatus comprising:
a stop signal conversion means 20 for outputting a running signal of a rectangular shape using the rectangular shaped signal during the running state of the vehicle, and for outputting a stop signal of a low-level signal or a high-level signal after converting the rectangular shaped signal of a high-level signal or a low-level signal generated by the vehicle-speed sensor 10 during the stop state of the vehicle until the vehicle is moved or running;
an accelerator pedal sensing means 40 installed so as to detect the pressing of an accelerator pedal, outputting an acceleration signal of a high-level signal or a low-level signal during an accelerator pedal pressing state, and outputting a stoppage signal during an acceleration pedal releasing state;
a stopping/running judgement means 50 having a first input terminal and a second input terminal each of which is connected to each output terminal of the stop signal conversion means 20 and the accelerator pedal sensing means 40, respectively, outputting an open signal in the running state in which the running signal or the acceleration signal is inputted from one output terminal of the stop signal conversion means 20 and the accelerator pedal sensing means 40 to the first input terminal or the second input terminal, and outputting a close signal in the stop state in which the stop signal and the stoppage signal are inputted from both output terminals of the stop signal conversion means 20 and the accelerator pedal sensing means 40 to the first input terminal and the second input terminal;
a switch means 60 which is operated or is not operated by the open signal or the close signal outputted from the stopping/running judgement means 50; and
an electromagnetically operated switching valve 70 which is installed in a hydraulic or pneumatic brake line L connected to the wheel brake device 80, and is controlled by the switch means 60 in such a manner that the hydraulic or pneumatic brake line L becomes open when the switch means 60 is operated or is not operated by the open signal from the stopping/running judgement means 50 and the hydraulic or pneumatic brake line L becomes closed when the switch means 60 is operated or is not operated by the close signal from the stopping/running judgement means 50, thereby maintaining the braked stop state of the vehicle and preventing the movement of the vehicle before the running of the vehicle
or just before the pressing of the accelerator pedal after the stoppage of the vehicle although the brake pedal may be released.

2. The apparatus for automatically braking a vehicle in a stop state according to claim 1:
wherein the stop signal conversion means 20 comprises an exclusive OR gate EX-OR having a first input terminal and a second input terminal, a resistor R1, and a condenser C1, a signal of the vehicle-speed sensor 10 being inputted to said first input terminal of the exclusive OR gate EX-OR as it is, and the signal of the vehicle-speed sensor 10 being inputted to said second input terminal of the exclusive OR gate EX-OR after a first delayed time T1 by means of the resistor R1 and the condenser C1, so that, when the close signal is a low-level signal and a signal of the vehicle-speed sensor 10 detecting a stop state of the vehicle is a high-level signal, the high-level signal can be converted to a low-level signal;
wherein the accelerator pedal sensing means 40 comprises a switch means having a first to a third contact points a, b and c, and installed in a relationship with the accelerator pedal in such a manner that the third contact point c as the output terminal thereof can be switched between the first contact point a connected to an electric power source (+12V) of the vehicle by operating a key switch of the vehicle for outputting the acceleration signal of a high-level signal in the accelerator pedal pressing state and the second contact point b connected to ground of the vehicle for outputting the stoppage signal of a low-level signal in the accelerator pedal depressing state;
wherein the stopping/running judgement means 50 comprises an OR gate OR whose first input terminal and second input terminal are connected to the stop signal conversion means 20 and the third contact point c of the accelerator pedal sensing means 40, and which outputs the rectangular shaped running signal or the acceleration signal of a high-level signal, or the stoppage signal of a low-level signal as the open or close signal;
wherein the switch means 60 comprises a transistor means Q of an NPN type which base is connected to an output terminal of the OR gate OR and which is driven when the open signal is inputted and is not driven when the close signal of a low-level signal is inputted, and a relay RL which is connected between the electric power source (+12V) during the operation of the key switch and a collector of the transistor means Q, and which is energized in the driven state of the transistor means Q and de-energized in the non-driven state.

3. The apparatus for automatically braking a vehicle in a stop state according to claim 1:
wherein the stop signal conversion means 20 comprises an exclusive OR gate EX-OR having a first input terminal and a second input terminal, a resistor R1, and a condenser C1, a signal of the vehicle-speed sensor 10 being inputted to said first input terminal of the exclusive OR gate EX-OR as it is, and the signal of the vehicle-speed sensor 10 being inputted to said second input terminal of the exclusive OR gate EX-OR after a first delayed time T1 by means of the resistor R1 and the condenser C1, so that, when the close signal is a high-level signal and a signal of the vehicle-speed sensor 10 detecting a stop state of the vehicle is a high-level signal, the high-level signal can be converted to a low-level signal;
wherein the accelerator pedal sensing means 40 comprises a switch means having a first to a third contact points a, b and c, and installed in a relationship with the accelerator pedal in such a manner that the third contact point c as the output terminal thereof can be switched between the first contact point a connected to an electric power source (+12V) of the vehicle by operating a key switch of the vehicle for outputting the acceleration signal of a high-level signal in the accelerator pedal pressing state and the second contact point b connected to ground of the vehicle for outputting the stoppage signal of a low-level signal in the accelerator pedal depressing state;
wherein the stopping/running judgement means 50 comprises a NOR gate NOR whose first input terminal and second input terminal are connected to the stop signal conversion means 20 and the third contact point c of the accelerator pedal sensing means 40, and which outputs, as the open signal or the close signal, a signal inverted by the rectangular shaped running signal or the acceleration signal of a high-level signal, or the stoppage signal of a low-level signal;
wherein the switch means. 60 comprises a transistor means Q of an NPN type which base is connected to an output terminal of the NOR gate NOR through the resistor R2 and which is not driven when the open signal is inputted and is driven when the close signal of a high-level signal is inputted, and a relay RL which is connected between the electric power source (+12V) during the operation of the key switch and a collector of the transistor means Q, and which is energized in the driven state of the transistor means Q and de-energized in the non-driven state.

4. The apparatus for automatically braking a vehicle in a stop state according to any one of claims 1 to 3,
wherein said apparatus further comprises a brake pedal sensing means 30 which detects the pressing of the brake pedal and is connected between the output terminal of the stop signal conversion means 20 and the first input terminal of the stopping/running judgement means 50 so as to output a stop signal after blocking a signal from the stop signal conversion means 20 during a brake pedal pressing state, and output the running signal or the stop signal from the stop signal conversion means 20 to the first input terminal of the stopping/running judgement means 50 during a brake pedal releasing state.

5. The apparatus for automatically braking a vehicle in a stop state according to claim 1:
wherein the stop signal conversion means 20 comprises an exclusive OR gate EX-OR having a first input terminal and a second input terminal, a resistor R1, and a condenser C1, a signal of the vehicle-speed sensor 10 being inputted to said first input terminal of the exclusive OR gate EX-OR as it is, and the signal of the vehicle-speed sensor 10 being inputted to said second input terminal of the exclusive OR gate EX-OR after a first delayed time T1 by means of the resistor R1 and the condenser C1, so that, when the close signal is a low-level signal and a signal of the vehicle-speed sensor 10 detecting a stop state of the vehicle is a high-level signal, the high-level signal can be converted to a low-level signal;
wherein the accelerator pedal sensing means 40 comprises a switch means having a contact point c connected to an electric power source (+12V) of the vehicle by operating a key switch of the vehicle and a contact point a connected to the stopping/running judgement means 50, and installed in a relationship with the accelerator pedal in such a manner that the contact points a and c will become open or connected to each other so as to output the acceleration signal of a high-level signal in the accelerator pedal pressing state, and the stoppage signal of a low-level signal in an accelerator pedal depressing state, to the stopping/running judgement means 50;
wherein the stopping/running judgement means 50 is constructed by connecting the output terminal of the stop signal conversion means 20 and the contact point a of the accelerator pedal sensing means 40 so as to output, as the open signal or the close signal, the rectangular shaped running signal or the acceleration signal of a high-level signal, or the stoppage signal of a low-level signal;
wherein the switch means 60 comprises a transistor means Q of an NPN type which base is commonly connected to an output terminal of the stop signal conversion means 20 and the contact point a of the accelerator pedal sensing means 40 and which is driven when the open signal is inputted and is not driven when the close signal of a low-level signal is inputted, and a relay RL which is connected between the electric power source (+12V) during the operation of the key switch and a collector of the transistor means Q, and which is energized in the driven state of the transistor means Q and de-energized in the non-driven state.

6. The apparatus for automatically braking a vehicle in a stop state according to claim 1 or claim 2, wherein the stopping/running judgement means 50 further comprises a resistor R2, a condenser C2 and a resistor R3 having a resistance greater than that of the resistor R2 so as to output the open signal in which a potential of the rectangular shaped running signal is maintained above a potential maintaining a collector current above a current for maintaining a energized state of the relay RL, thereby preventing from releasing the driven state of transistor means Q and the relay RL of the switch means 60 when the rectangular shaped running signal is inputted and outputted from the OR gate OR as the open signal, and preventing from closing the electromagnetically operated switching valve 70 periodically.

7. The apparatus for automatically braking a vehicle in a stop state according to claim 1, 2, 3 or 5, wherein the electromagnetically operated switching valve 70 is of a normally closed type and functions as a parking brake by supplying the electric power source (+12V) of the vehicle to the automatic brake apparatus when a key switch of the vehicle is operated and maintaining the hydraulic or pneumatic brake line L in the close state through the electromagnetically operated switching valve 70 in the parking state in which the electric power source (+12V) of the vehicle is cut off, said electromagnetically operated switching valve 70 further comprising an emergency bypath valve (72) of a manual type in parrallel to the electromagnetically operated switching valve 70 so as to release the braking force in the parking state.

8. The apparatus for automatically braking a vehicle in a stop state according to claim 1, 2, 3 or 5:
wherein the electromagnetically operated switching valve 70 is installed symmetrically for the vehicle wheels in the hydraulic or pneumatic brake line L, and is not installed in the particular vehicle wheel to which the vehicle-speed sensor 10 is installed and in the vehicle wheel symmetrical to the particular vehicle wheel; and
wherein a check valve 71 is further installed in parallel to the electromagnetically operated switching valve 70 so as to transmit increased pressure of the hydraulic or pneumatic brake line L when the electromagnetically operated switching valve 70 is closed.

9. A method of automatically braking in a stop state a vehicle, which has a vehicle-speed sensor 10 generating a rectangular shaped signal for representing a running speed of the vehicle, and brakes the vehicle by operating a wheel brake device 80 by means of a brake pedal, the method comprising the steps of:
detecting one of a high-level signal and a low-level signal as it is if the one of a high-level signal and a low-level signal is generated by the vehicle-speed sensor 10 when the vehicle stops by pressing the brake pedal;
detecting one of a high-level signal and a low-level signal converted from the other one of a high-level signal and a low-level signal by a stop signal conversion means 20 if the other one of a high-level signal and a low-level signal is generated by the vehicle-speed sensor 10 when the vehicle stops by pressing the brake pedal, and detecting the converted one;
closing a hydraulic or pneumatic brake line L and braking the vehicle by detecting the stop state of the vehicle using a single signal from the vehicle-speed sensor 10 although the pressing of the brake pedal may be released.

10. The method of automatically braking a vehicle in a stop state according to claim 9, wherein the stop signal conversion means 20 comprises an exclusive OR gate EX-OR having a first input terminal and a second input terminal, a resistor R1, and a condenser C1, a signal of the vehicle-speed sensor 10 being inputted to said first input terminal of the exclusive OR gate EX-OR as it is, and the signal of the vehicle-speed sensor 10 being also inputted to the second input terminal of the exclusive OR gate EX-OR after a first delayed time T1 by means of the resistor R1 and the condenser C1, so that the low-level signal can be outputted from the exclusive OR gate EX-OR after a first delayed time T1 at the time of the vehicle stop.
